(19) United States
(12) Patent Application Publication
(10) Pub. No.: US 2016/0310872 A1
(43) Pub. Date: Oct. 27, 2016

(54) FEEDWELL SYSTEM

(71) Applicant: SYNCRUDE CANADA LTD. in trust for the owners of the Syncrude Project as such owners exist now and, Fort McMurray (CA)

(72) Inventors: JONATHAN SPENCE, Edmonton (CA); BARRY BARA, Edmonton (CA); KONSTANTIN POUGATCH, Port Moody (CA); DARWIN EDWARD KIEL, New Westminster (CA); TREVOR LLOYD HILDERMAN, Port Coquitlam (CA)

(21) Appl. No.: 14/693,695

(22) Filed: Apr. 22, 2015

(51) Int. Cl. B01D 21/00; B01D 21/24

(52) U.S. Cl. CPC B01D 21/0087; B01D 21/0042; B01D 21/2427; B01D 21/2494

(57) ABSTRACT

A feedwell system for use in a separation vessel is provided, comprising a substantially cylindrical chamber having a bottom floor with an opening therein; an inlet for introducing a feed stream into the substantially cylindrical chamber; and a deflector plate having a generally conical shape and spacedly position beneath the opening of the bottom floor, the deflector plate having at least one aperture therethrough; whereby the feed stream exits the opening of the bottom floor onto the deflector plate having at least one aperture therethrough.

### FIELD OF THE INVENTION

The present invention relates generally to a feedwell system for separation vessels such as those used for separating bitumen from an oil sand/water slurry and, more particularly, to a feedwell system having a bottom deflector pate.

### BACKGROUND OF THE INVENTION

Separation vessels such as gravity separation vessels, thickeners, and the like, are used in various fields to separate solid particles from liquid in a slurry. For example, gravity separation vessels are used in the oil sands industry to separate bitumen and water from solids in an oil sand slurry.

Bitumen extracted from oil sand, such as oil sand mined in the Fort McMurray region of Alberta, is generally made up of water-wet sand grains and viscous bitumen. To eventually produce a commercial petroleum product from oil sand, the bitumen must be removed from the sand. To remove the bitumen from the sand/bitumen mixture, the oil sand is often crushed and then mixed with water to form an oil sand/water slurry. This slurry can then be subjected to what is commonly referred to as “pipeline conditioning” by pumping the slurry some distance through a pipeline, commonly called a hydrotransport pipeline. The conditioned slurry is then typically diluted with a fluid, such as water, to form a diluted slurry. By diluting the slurry, the density of the slurry can be altered to a more desirable density for separation of the bitumen in the slurry. The diluted slurry is then fed to a gravity separation vessel such as a primary separation vessel (PSV) where the relatively quiescent conditions and entrained air in the bitumen allows a significant portion of the bitumen to float towards the top of the gravity separation vessel and collect in a layer of froth, commonly called primary bitumen froth. This primary bitumen froth can be recovered and further treated to eventually be made into a commercial petroleum product.

In addition to the bitumen froth layer, typically a middlings layer and a tailings layer are also formed in the gravity separation vessel. The middlings layer forms below the bitumen froth layer and the tailings layer forms at the bottom of the gravity separation vessel. The middlings and tailings layers are removed and often further treated to extract out additional bitumen that remains in these layers. However, the bitumen in these layers is not as easily recoverable.

To try and increase the quality of the bitumen froth that collects in the bitumen froth layer, an underwash layer is often purposely formed above the middlings layer and below the bitumen froth layer in the PSV. The underwash layer is typically formed by introducing heated liquid, such as water, in between the middlings layer and the bitumen froth layer. The heated liquid in the underwash layer can help to increase the temperature of the bitumen froth produced. The heated underwash water can also replace the middlings in the bitumen froth as it is formed, thereby reducing the amount of solids in the froth.

To enhance gravity separation, quiescent conditions need to be maintained in the PSV. One of the main factors affecting these quiescent conditions is the introduction of the slurry to the gravity separation vessel. Typically, these gravity separation vessels are operated as a continuous process with slurry continuously being introduced into the vessel while end products, such as bitumen froth, a tailings stream, etc. are continuously being removed from the vessel. The introduction of slurry can have a detrimental effect on these quiescent conditions due to the high velocity of the feed and the recirculation currents formed by the separation of the coarse solids from the slurry. Additionally, the introduction of the slurry can have a detrimental effect on the underwash layer, with swirling and vortices created in the gravity separation vessel by the introduction of the slurry affecting the stability of the underwash layer and causing an erosion of the underwash layer.

### SUMMARY OF THE INVENTION

It has been discovered using both laboratory and computational fluid dynamics (CFD) simulations that coarse solids present in an oil sand slurry flowing out of conventional feedwells in primary separation vessels (PSV) create a plunging flow pattern underneath the feedwell. This flow pattern has strong downward velocities which can entrain bitumen droplets and carry them into the PSV underflow, resulting in bitumen losses. FIG. 7 shows such a flow pattern. It can be seen in FIG. 7 that in this particular feedwell design, there are high velocities beneath the feedwell and the corresponding plunging flow pattern can be seen.

It was discovered that bitumen losses from the PSV could be significantly reduced by minimizing the plunging flow pattern beneath the feedwell seen in FIG. 7. Thus, in a first aspect, a feedwell system for use in a separation vessel is provided, comprising:
a substantially cylindrical chamber having a bottom floor with an opening therein;
an inlet for introducing a feed stream into the substantially cylindrical chamber; and
a deflector plate having a generally conical shape and spacedly position beneath the opening of the bottom floor, the deflector plate having at least one aperture therethrough;
   whereby the feed stream exits the opening of the bottom floor onto the deflector plate having at least one aperture therethrough.

In one embodiment, the feedwell system further comprises an extension pipe attached to the opening to divert the flow of the feed stream from the opening directly onto the center or apex of the conical deflector plate. The extension pipe favors an axisymmetric down-flow which impacts onto the apex producing a circumferentially uniform discharge. It is understood that the opening must be of a sufficient size to allow the passage of the entire feed stream, including any lumps that may be present therein.

In another embodiment, the feedwell further comprises at least one substantially vertical baffle located within the substantially cylindrical chamber for reducing the momentum of the feed stream as it enters the substantially cylindrical chamber. In one embodiment, the width of the baffles may increase in the rotation direction as you move away from the inlet with the thinnest baffle position directly in line with the feed stream inlet, thus, preventing excessive erosion of the baffles located closest to the feed inlet point. It is understood that baffles can be different shapes as known in the art, for example, L shaped baffles can be used.

In one embodiment, the deflector plate comprises a plurality of apertures in the form of slots along the perimeter of the deflector plate. In one embodiment, there are four slots. In one embodiment, the deflector plate has a substantially horizontal outer periphery and the at least one aperture extends to the substantially horizontal outer periphery.

In another aspect, a feedwell system for a separation tank is provided, comprising:
a substantially cylindrical chamber having a bottom floor with an opening therein;
an inlet for introducing a feed stream into the substantially cylindrical chamber;
a first deflector plate having a second opening and a generally frusto-conical shape and positioned beneath the first opening such that the feed is directed from the first opening to the second opening of the first deflector plate; and
a second deflector plate having a generally conical shape and spacedly positioned below the first deflector plate so that when the feed goes through the second opening it is distributed between the two deflector plates, the second deflector plate having at least one aperture therethrough.

In one embodiment, the second deflector plate comprises a plurality of apertures in the form of slots along the perimeter of the deflector plate. In one embodiment, there are four slots. In one embodiment, the second deflector plate has a substantially horizontal outer periphery and the at least one aperture extends to the substantially horizontal outer periphery. In another embodiment, the first deflector plate also has a substantially horizontal outer periphery.

It is understood that the space between the first and second deflector plates should be sufficient to allow any large lumps in the feed stream to pass therebetween. For example, when the feed is oil sand slurry, it is possible to have lumps therein having a diameter of up to 4 inches. In one embodiment, the first and second deflector plates are substantially parallel. However, it is understood that the plates can be either convergent or divergent, provided, however, that the narrowest space between the plates is sufficient to allow the passage of the largest lumps in the feed stream therebetween.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the following figures. It is understood that the drawings provided herein are for illustration purposes only and are not necessarily drawn to scale.

FIG. 1 is a side view of one embodiment of a feedwell system for introducing slurry to a gravity separation vessel.

FIG. 2 is a sectional top view of the feedwell system of FIG. 1 along line AA′.

FIG. 3 is a schematic side sectional view of the feedwell system of FIG. 2.

FIG. 4 is a side view of another embodiment of a feedwell system for introducing slurry to a gravity separation vessel.

FIG. 5 is a perspective view of the feedwell system of FIG. 4. FIG. 6 is a side view of another embodiment of a feedwell system for introducing slurry to a gravity separation vessel.

FIG. 7 is a perspective view of the feedwell system of FIG. 6.

FIG. 8 is a side view of another embodiment of a feedwell system for introducing slurry to a gravity separation vessel.

FIG. 9 shows a CFD simulation of a feedwell system where the deflector plate does not have apertures therethrough.

FIG. 10 shows a CFD simulation (axial velocity contours) of a feedwell system of the present invention where the deflector plate has a number of apertures (15° slots) therethrough.

FIG. 11 is a bar graph showing bitumen and sand recovery for five different feedwell systems tested.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

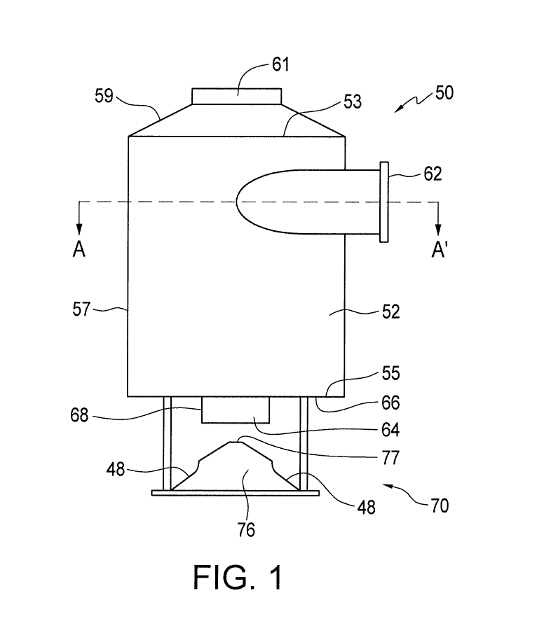

FIGS. 1, 2 and 3 illustrate one embodiment of a feedwell system of the present invention. The feedwell system 50 comprises substantially cylindrical chamber 52 having an upper perimeter 53, a lower perimeter 55 and a substantially continuous wall 57 with an inlet 62 provided on an upper portion of the substantially cylindrical chamber 52. The inlet 62 is provided so that it is oriented tangentially to the continuous wall 57 causing the slurry that is introduced into the feedwell system 50 to be introduced into the substantially cylindrical chamber 52 of the feedwell system 50 in a direction substantially tangential to the continuous wall 57.

Bottom floor 66 of the substantially cylindrical chamber 52 of the feedwell system 50 has an opening 64 which can have an extension pipe 68 extending therefrom. The opening 64 can be positioned in the center of the bottom plate 66 of the substantially cylindrical chamber 52 and can be sized so that it constrains the amount of slurry exiting the feedwell 50. In one embodiment, the opening 64 has a substantially smaller area than the area of the bottom floor 66. By sizing the opening 64 based on the flow rate that will be used for the slurry entering the feedwell 50 through the inlet 62, the feedwell 50 can be designed so that a desired level of slurry can be maintained in the feedwell 50. If an extension pipe 68 is provided, the extension pipe 68 can help to cause a uniform axisymmetric down-flow in the slurry exiting the substantially cylindrical chamber 52 through the opening 64

A deflector assembly 70 can be provided below the opening 64 in the bottom floor 66. The deflection assembly 70 can have a deflector plate 76 positioned spaced below the opening 64 in the bottom floor 66 or below extension pipe 68. In one aspect, the deflector plate 76 can be generally conically-shaped with a apex 77 of the deflector plate 76 positioned spacedly below the opening 64 in the bottom plate 66 so that slurry discharged out of the substantially cylindrical chamber 52 of the feedwell 50 is deflected by the apex 77 of the deflector plate 76 to follow the downward slant of the deflector plate 76.

The feedwell 50 may further have a lid 59 at the upper perimeter edge 53 having an opening 61, to prevent the slurry feed from splashing out while still allowing venting.

Deflector plate 76 further comprises apertures 48. The apertures 48 in this embodiment are in the form of circular openings or cutouts at or near the outer periphery of the deflector plate 76. In one embodiment, the apertures can be any shaped opening or cutout. In one embodiment, the apertures may extend inwardly from the periphery of the conically-shaped deflector plate 76.

Thus, in the embodiments shown in FIGS. 1, 2 and 3, as slurry is discharged downwardly out of the opening 64 in the bottom floor 66 towards the generally conically-shaped deflector plate 76, the deflector plate 76 can redirect at least some of the flow of slurry downwards and outwards along its length. The presence of apertures 48 is to decrease the pressure difference between the top and the bottom sides of the deflector plate 76, thereby allowing a portion of the flow to bypass the deflector plate 78 through the apertures 48. This reduces and, in some instances, substantially eliminates the conditions which cause the slurry to wrap around the bottom of the plate and form a plunging jet.

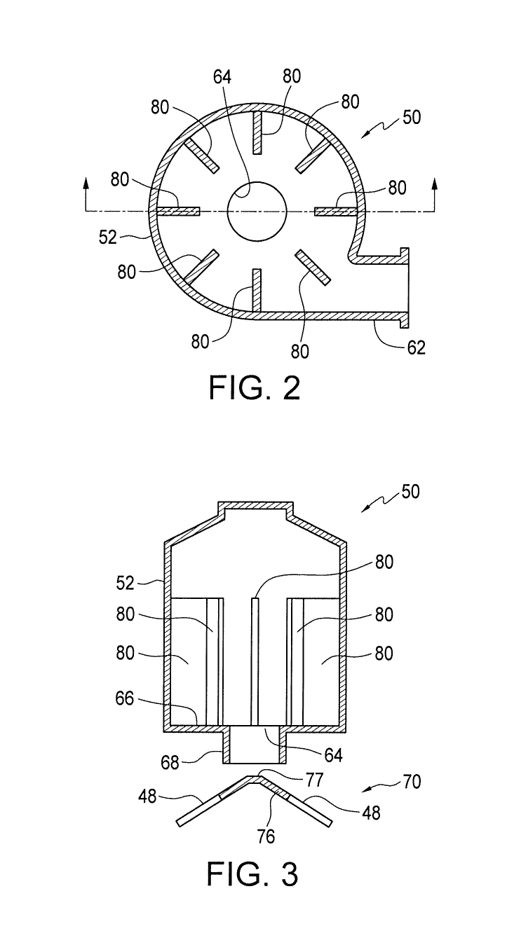

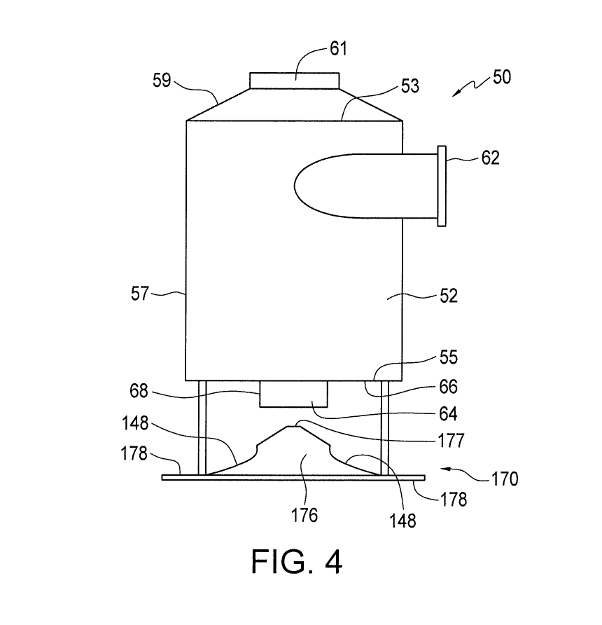

As shown in FIGS. 2 and 3, in one embodiment, a number of baffles 80 can be provided in the substantially cylindrical chamber 52 of the feedwell 50 to prevent or minimize swirling flows and/or vortices in the slurry. In one aspect, the baffles 80 can be positioned so that the baffles are oriented radially from the center of the feedwell 50. The baffles 80 can extend from the walls of the substantially cylindrical chamber 52 of the feedwell system 50 partially towards the center of the substantially cylindrical chamber 52 and the width of the baffles may increase in the rotation direction as you move away from the inlet with the thinnest baffle position directly in line with the feed stream inlet, thus, preventing excessive erosion of the baffles located closest to the feed inlet point.

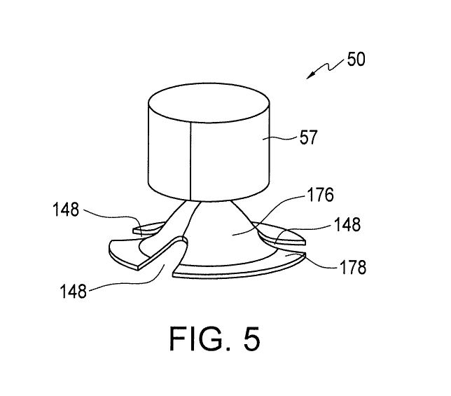

In the embodiment shown in FIG. 4, a deflector assembly 170 can be provided below the opening 64 in the bottom floor 66. The deflection assembly 170 can have a deflector plate 176 positioned spaced below the opening 64 in the bottom floor 66 or below extension pipe 68. In one aspect, the deflector plate 176 can be generally conically-shaped with a apex 177 of the deflector plate 176 positioned spacedly below the opening 64 in the bottom plate 66 so that slurry discharged out of the substantially cylindrical chamber 52 of the feedwell 50 is deflected by the apex 177 of the deflector plate 176 to follow the downward slant of the deflector plate 176. A substantially horizontal periphery portion 178 of the deflector plate 176 can extend outwards to attempt to redirect the flow of slurry exiting the feedwell 50 horizontally.

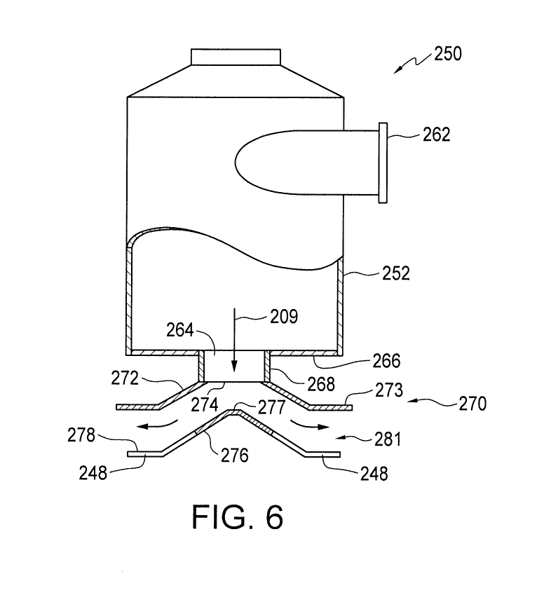

In this embodiment, there are four inwardly extending apertures 148 in the form of slots (15° cutouts), which slots are evenly spaced around the periphery of the substantially horizontal periphery portion 178. The apertures 148 can be seen more clearly in FIG. 5. In one embodiment, the substantially horizontal periphery portion 178 has a radius of about 20% of the radius of the deflector plate 176. In one embodiment, there are four inwardly extending apertures in the form of slots (15° cutouts) and the substantially horizontal periphery portion 178 has a radius of about 50% of the radius of the deflector plate 176. Thus, as the flow of slurry reaches the periphery portion 178, the substantially horizontal periphery portion 178 can direct this flow substantially horizontally and outwards. The apertures 148 decreases the pressure difference between the top and the bottom sides of the deflector plate having the periphery extension, thereby allowing a portion of the flow to bypass the deflector plate 178 through the apertures 148. This reduces and, in some instances, substantially eliminates the conditions which cause the slurry to wrap around the bottom of the plate and form a plunging jet.

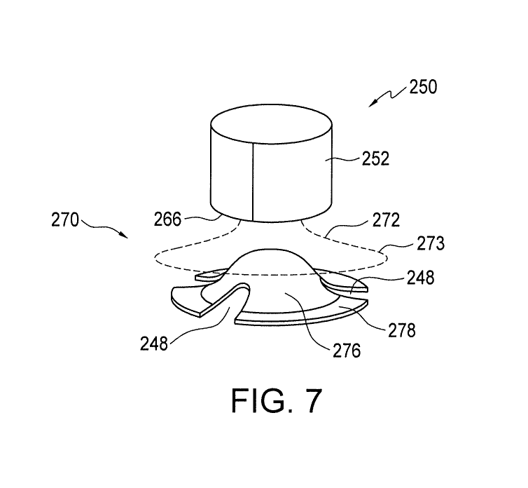

FIGS. 6 and 7 illustrate another embodiment of the feedwell system of the present invention. In this embodiment, feedwell system 250 comprises a substantially cylindrical chamber 252 with a tangentially oriented inlet 262 provided on an upper portion of the substantially cylindrical chamber 252. An opening 264 can be provided on a bottom floor 266 of the chamber 252 of the feedwell 250. The opening 264 can have an extension pipe 268 extending downwards therefrom and can be positioned in the center of the bottom floor 266. The opening 264 can be sized so that it constrains the amount of slurry exiting the feedwell 250 to keep a desired level of slurry in the walled member 252 of the feedwell 250.

In one aspect, a number of baffles can be provided in the substantially cylindrical chamber to reduce swirling of slurry in the substantially cylindrical chamber of the feedwell system.

A deflector assembly 270 can be provided below the opening 264 in the bottom floor 266. The deflection assembly 270 can have a first deflector plate 272 and a second deflector plate 276. In one aspect, the first deflector plate 272 has a generally frusto-conical shape and an opening 274, which opening 274 is positioned immediately below opening 264 of the bottom floor 266. In one embodiment, the opening 274 is connected to opening 264 by an extension pipe 268. The second deflector plate 276 can be generally conically-shaped with a apex 277 of the deflector plate 276 positioned spacedly below the opening 274 of the first deflector plate 272 so that slurry 209 discharged out of the walled member 252 flows in between the space formed between the two deflector plates 272 and 276. Thus, the feed is deflected by the apex 277 of the second deflector plate 276 to follow the downward slant of the second deflector plate 276. A substantially horizontal periphery portion 278 of the second deflector plate 276 can extend outwards to attempt to redirect the flow of slurry horizontally. A similar substantially horizontal periphery portion 273 may extend from the first deflector plate 272.

The first deflector plate 272 and the second deflector plate 276 act in conjunction to direct at least a substantial portion of the flow of slurry entering a separator vessel from the feedwell system 250 outwardly in a substantially horizontal direction. However, as previously discussed, the slurry flowing through the opening 264 to the deflection assembly 270 can create a plunging flow pattern. This flow pattern has strong downward velocities which can, for example, entrain bitumen droplets and carry them into the PSV underflow, resulting in bitumen losses. Thus, the second deflector plate 276 can be provided with at least one aperture 248, and an embodiment of which aperture 248 can be seen more clearly in the perspective view of feedwell system 250 in FIG. 7.

It can be seen in FIG. 7 that, in this embodiment, deflector plate 276 has a substantially horizontal periphery portion 278 and that the apertures 248 are in the form of slots extending inwardly from the outer periphery of the substantially horizontal periphery portion 278. In one embodiment, there are four inwardly extending apertures in the form of slots (15° cutouts), which slots are evenly spaced around the periphery of the substantially horizontal periphery portion. In one embodiment, the substantially horizontal periphery portion 278 has a radius of about 20% of the radius of the deflector plate 276. In one embodiment, there are four inwardly extending apertures in the form of slots (15° cutouts) and the substantially horizontal periphery portion 278 has a radius of about 50% of the radius of the deflector plate 276. The first deflector plate 272 having a substantially horizontal periphery portion 273 is shown in phantom in FIG. 7.

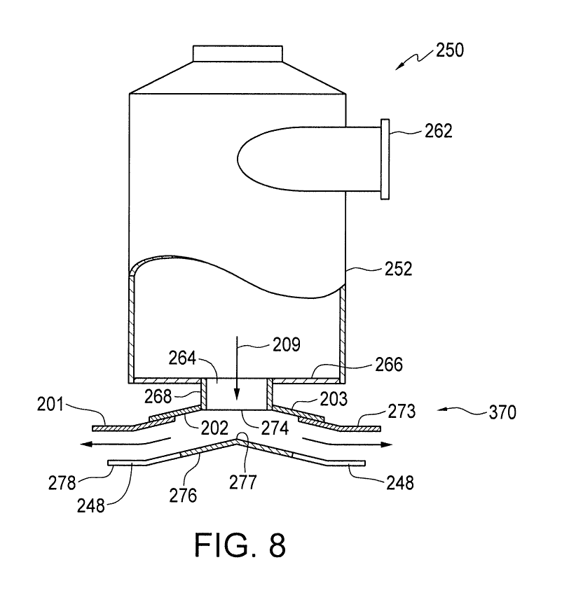

FIG. 8 illustrates another embodiment of the feedwell system of the present invention. In this embodiment, deflector assembly 370 can be provided below the opening 264 in the bottom floor 266 of the feedwell cylindrical chamber. The deflection assembly 370 can have a first deflector plate 201 and a second deflector plate 276. In one aspect, the first deflector plate 201 has a generally frusto-conical shape and an opening 274, which opening 274 is positioned immediately below opening 264 of the bottom floor 266. In one embodiment, the opening 274 is connected to opening 264 by an extension pipe 268. In this embodiment, the first deflector plate 201 is designed to protect the underwash layer from erosion. In particular, first deflector plate 201 comprises a series of ventilation openings 202 adjacent to opening 274 which is connected via extension pipe 268 to the opening 264. The ventilation openings 202 limit the formation of an adverse pressure gradient by providing pressure communication, reducing the risk of local separation and circumferential mal-distribution. First deflector plate 201 further comprises structural supports 203 to support the first deflector plate 201 and to maintain the correct vent opening size to protect the underwash layer from entrainment by the feed flow 209.

The second deflector plate 276 can be generally conically-shaped with a apex 277 of the deflector plate 276 positioned spacedly below the opening 274 of the first deflector plate 201 so that slurry 209 discharged out of the walled member 252 flows in between the space formed between the two deflector plates 201 and 276. Thus, the feed is deflected by the apex 277 of the second deflector plate 276 to follow the downward slant of the second deflector plate 276. A substantially horizontal periphery portion 278 of the second deflector plate 276 can extend outwards to attempt to redirect the flow of slurry horizontally. A similar substantially horizontal periphery portion 273 may extend from the first deflector plate 201. The first deflector plate 201 and the second deflector plate 276 act in conjunction to direct at least a substantial portion of the flow of slurry entering a separator vessel from the feedwell system 250 outwardly in a substantially horizontal direction.

However, as previously discussed, the slurry flowing through the opening 264 to the deflection assembly 370 can create a plunging flow pattern. This flow pattern has strong downward velocities which can, for example, entrain bitumen droplets and carry them into the PSV underflow, resulting in bitumen losses. Thus, the second deflector plate 276 can be provided with at least one aperture 248, which at least one aperture can be a circular or other shaped cutout or a slot as shown in FIGS. 5 and 7.

### Example 1

Computational fluid dynamics (CFD) simulations were performed for five different feedwell systems. Each feedwell system comprised a top deflector plate and a bottom deflector plate.

The five designs tested were as follows:
bottom deflector plate without apertures and without a horizontal periphery portion (i.e., no radius extension);
bottom deflector plate without a horizontal periphery portion and with four apertures, i.e., four slots (15° cutouts);
bottom deflector plate with a horizontal periphery portion increasing its radius by 20% and with four apertures, i.e., four slots (15° cutouts);
bottom deflector plate with a horizontal periphery portion increasing its radius by 50% and with four apertures, i.e., four slots (15° cutouts); and
bottom deflector plate with a horizontal periphery portion increasing its radius by 50% with no apertures.

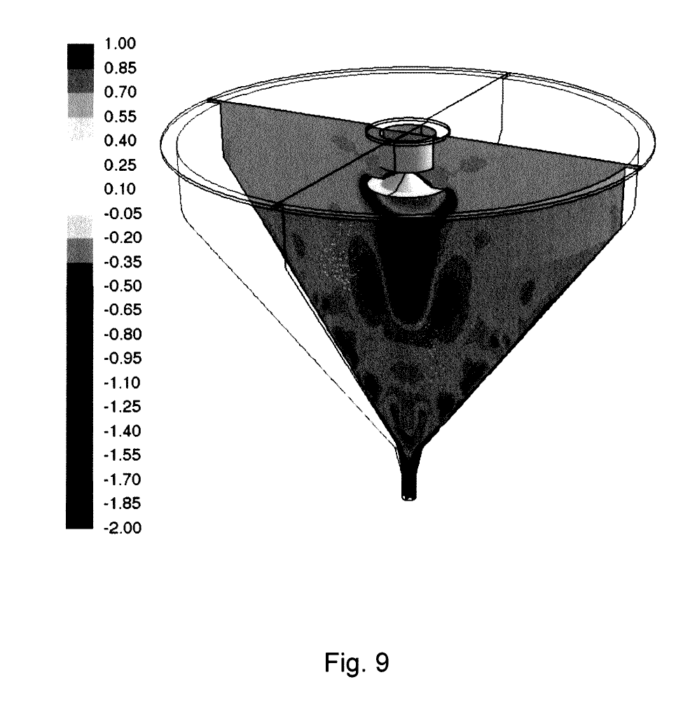

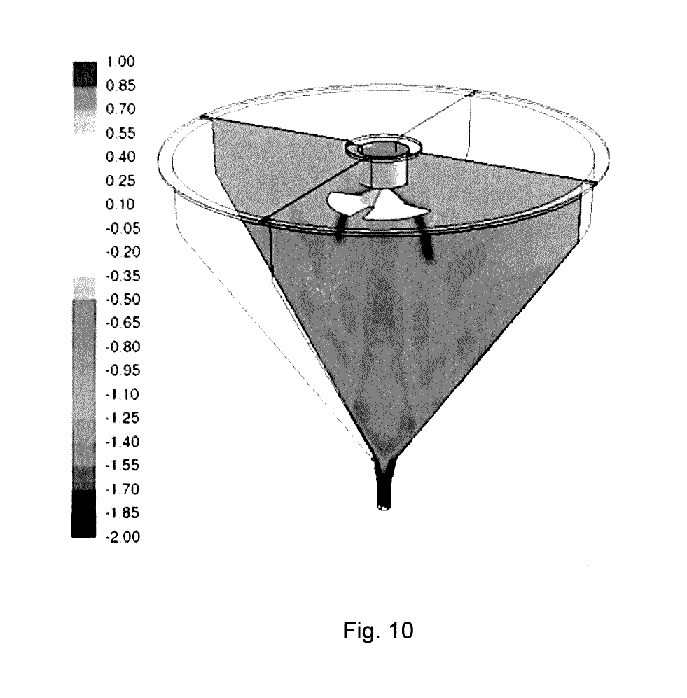

By using CFD, it was discovered that the best performing feedwell system was the one having a bottom deflector plate with a horizontal periphery portion that increased its radius by 50% and that had four apertures, i.e., four slots (15° cutouts). The CFD results for this design can be seen in FIG. 10. When compared to FIG. 9, which shows the CFD of a feedwell system comprising a bottom deflector plate without apertures and without a horizontal periphery portion (i.e., radius extension), it can be seen that the downward plunging of feed shown in FIG. 9 was virtually eliminated in FIG. 10.

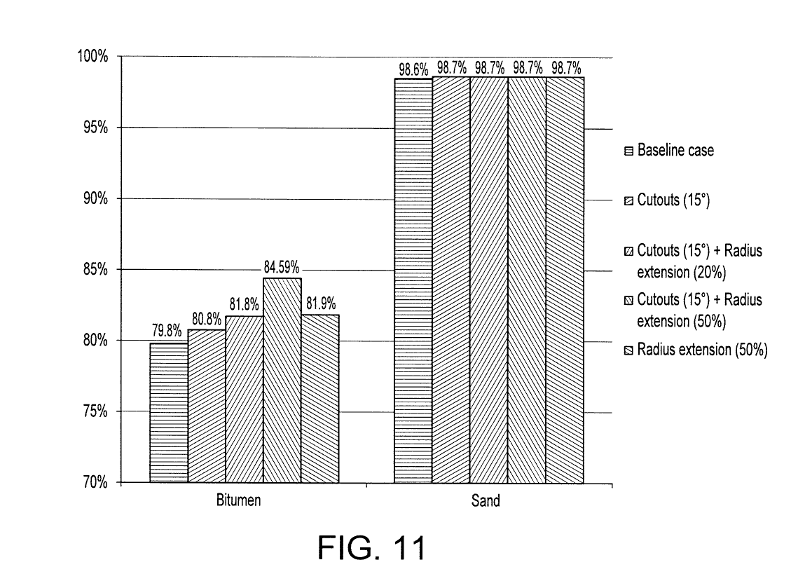

Bitumen recovery and sand recovery were also determined for each feedwell design described above. The feedwells were used in primary separation vessels (PSVs) and the feed used was oil sand slurry. FIG. 11 shows that for the base case, i.e., bottom deflector plate without apertures and without a horizontal periphery portion (i.e., no radius extension), 79.8% of the bitumen in the oil sand slurry was recovered to the froth in the PSV and 98.6% of the sand was rejected to the underflow. The feedwell design which gave the best bitumen recoveries was the design where the bottom deflector plate had a horizontal periphery portion which increased its radius by 50% and had four apertures, i.e., four slots (15° cutouts). In this design, bitumen recovery increased to 84.5% and sand recovery was either unaffected or slightly increased, indicating that solids were not remaining in the middlings and/or bitumen froth. It was shown that even without the deflector plate having a horizontal periphery portion, the inclusion of apertures (slots) to the bottom deflector plate resulted in improved bitumen recovery to 80.8%.

The previous description of the disclosed embodiments is provided to enable any person skilled in the art to make or use the present invention. Various modifications to those embodiments will be readily apparent to those skilled in the art, and the generic principles defined herein may be applied to other embodiments. Reference to an element in the singular, such as by use of the article “a” or “an” is not intended to mean “one and only one” unless specifically so stated, but rather “one or more”. Nothing disclosed herein is intended to be dedicated to the public regardless of whether such disclosure is explicitly recited in the claims.

1. A feedwell system for use in a separation vessel, comprising:
a substantially cylindrical chamber having a bottom floor with an opening therein;
an inlet for introducing a feed stream into the substantially cylindrical chamber; and
a deflector plate having a generally conical shape and spacedly position beneath the opening of the bottom floor, the deflector plate having at least one aperture therethrough;
whereby the feed stream exits the opening of the bottom floor onto the deflector plate having at least one aperture therethrough.

2. The feedwell system as claimed in claim 1, further comprising an extension pipe attached to the opening to divert the flow of the feed stream from the opening directly onto the center or apex of the conical deflector plate.

3. The feedwell system as claimed in claim 1, further comprising at least one substantially vertical baffle located within the substantially cylindrical chamber for reducing the momentum of the feed stream as it enters the substantially cylindrical chamber.

4. The feedwell system as claimed in claim 1, wherein the deflector plate comprises a plurality of apertures in the form of slots along the perimeter of the deflector plate.

5. The feedwell system as claimed in claim 1, wherein the deflector plate comprises four apertures in the form of slots along the perimeter of the deflector plate.

6. The feedwell system as claimed in claim 1, wherein the at least one aperture is a circular or other shaped cutout in the deflector plate.

7. The feedwell system as claimed in claim 1, wherein the deflector plate has a substantially horizontal outer periphery and the at least one aperture extends to the substantially horizontal outer periphery.

8. The feedwell system as claimed in claim 7, wherein the substantially horizontal outer periphery has a radius in the range of about 20 to about 50% of the radius of the deflector plate.

9. The feedwell system as claimed in claim 7, wherein the substantially horizontal outer periphery has a radius of about 20% of the radius of the deflector plate.

10. The feedwell system as claimed in claim 7, wherein the substantially horizontal outer periphery has a radius of about 50% of the radius of the deflector plate.

11. A feedwell system for a separation tank, comprising:
a substantially cylindrical chamber having a bottom floor with a first opening therein;
an inlet for introducing a feed stream into the substantially cylindrical chamber;
a first deflector plate having a second opening and a generally frusto-conical shape and positioned beneath the first opening such that the feed is directed from the first opening to the second opening of the first deflector plate; and
a second deflector plate having a generally conical shape and spacedly positioned below the first deflector plate so that when the feed goes through the second opening it is distributed between the two deflector plates, the second deflector plate having at least one aperture therethrough.

12. The feedwell system as claimed in claim 11, further comprising an extension pipe attached to the first opening to divert the flow of the feed stream from the first opening to the second opening of the first deflector plate.

13. The feedwell system as claimed in claim 11, further comprising at least one substantially vertical baffle located within the substantially cylindrical chamber for reducing the momentum of the feed stream as it enters the substantially cylindrical chamber.

14. The feedwell system as claimed in claim 11, wherein the second deflector plate comprises a plurality of apertures in the form of slots along the perimeter of the deflector plate.

15. The feedwell system as claimed in claim 11, wherein the second deflector plate comprises four apertures in the form of slots along the perimeter of the deflector plate.

16. The feedwell system as claimed in claim 11, wherein the at least one aperture is a circular or other shaped cutout in the deflector plate.

17. The feedwell system as claimed in claim 11, wherein the second deflector plate has a substantially horizontal outer periphery and the at least one aperture extends to the substantially horizontal outer periphery.

18. The feedwell system as claimed in claim 17, wherein the substantially horizontal outer periphery of the second deflector plate has a radius in the range of about 20 to about 50% of the radius of the deflector plate.

19. The feedwell system as claimed in claim 17, wherein the substantially horizontal outer periphery of the second deflector plate has a radius of about 20% of the radius of the deflector plate.

20. The feedwell system as claimed in claim 17, wherein the substantially horizontal outer periphery of the second deflector plate has a radius of about 50% of the radius of the deflector plate.

21. The feedwell system as claimed in claim 11, wherein the first deflector plate comprises at least one ventilation opening for limiting the formation of an adverse pressure gradient.

22. The feedwell system as claimed in claim 11, wherein the first deflector plate has a substantially horizontal outer periphery.
